(19) United States
(12) Patent Application Publication
(10) Pub. No.: US 2012/0036760 A1
(43) Pub. Date: Feb. 16, 2012

(54) FISHING LURE

(76) Inventor: Kenneth Henry Scarpace, JR., Manistee, MI (US)

(21) Appl. No.: 13/096,265

(22) Filed: Apr. 28, 2011

Related U.S. Application Data
(60) Provisional application No. 61/401,382, filed on Aug. 13, 2010.

(51) Int. Cl. A01K 85/01; A01K 99/00; A01K 85/00

(52) U.S. Cl. 43/42.06; 43/42.36; 43/42.53

(57) ABSTRACT

A fishing lure may include a body portion shaped to generally resemble a body of a baitfish. The body portion may include a head portion corresponding to a head of the baitfish and a tail portion corresponding to a tail of the baitfish. A cavity may be formed through an outer surface of the body portion for receiving a at least a portion of a live or dead fish, or any other quantity of any other animal tissue, therein. The fishing lure may be connected to a fishing line and may include one or more hooks.

### CROSS-REFERENCE TO RELATED APPLICATIONS

This application claims the benefit of U.S. Provisional Application No. 61/401,382, filed on Aug. 13, 2010. The entire disclosure of the above application is incorporated herein by reference.

### FIELD

The present disclosure relates to a fishing lure, and more particularly, to a fishing lure adapted to receive bait.

### BACKGROUND

This section provides background information related to the present disclosure and is not necessarily prior art.

Fishermen often use lures to attract fish while fishing as an alternative to live bait. When fishing with live bait, fishermen are concerned with keeping the bait alive in an easily transportable container until use. Then, assuming the bait stays alive until it is placed on a hook, the bait must stay alive in the water with a hook impaling its body for a long enough period of time to effectively attract fish. Furthermore, it is possible for a fish to bite a portion of the baitfish and/or remove the baitfish from the hook without becoming caught on the hook itself, effectively “stealing” the bait.

Lures can be brightly colored and shaped to resemble baitfish, and are often designed to withstand multiple bites from larger fish. Therefore, a single lure can be used over and over and on multiple fishing trips. Lures may alleviate concerns for keeping an ample supply of bait alive during a long fishing trip. However, typical fishing lures lack the scent and feel of an actual baitfish.

### SUMMARY

This section provides a general summary of the disclosure, and is not a comprehensive disclosure of its full scope or all of its features.

The present disclosure provides a fishing lure that may include a body portion shaped to generally resemble a body of a baitfish. The body portion may include a front portion corresponding to a head of the baitfish and an aft portion corresponding to a tail of the baitfish. A cavity may be formed through an outer surface of the body portion for receiving at least a portion of a live or dead fish, or any other quantity of any other animal tissue, therein.

In another form, the present disclosure provides a fishing lure that may include a body portion that may have a front end corresponding to a head of a baitfish and an aft end corresponding to a tail of the baitfish. The body portion may include a one-piece construction. An elongated slot may be formed in the body portion and may extend through an outer surface of the body portion and along a longitudinal axis of the body portion. The elongated slot may extend through the aft end of the body portion from an intermediate location between the front and aft ends of the body portion. A first aperture may extend laterally through an entire lateral width of the body portion and the elongated slot. A hook may extend from the body portion proximate the elongated slot.

In another form, the present disclosure provides a method that may include securing a lure to a fishing line. The lure may be shaped to resemble a baitfish and having a hook connected thereto. At least one portion of at least one of a live baitfish or a dead baitfish may be provided and secured to the lure. The lure may be placed in a body of water, and relative motion between the water and the lure with the at least one portion of the at least one of the live baitfish or the dead baitfish secured to the lure may simulate a swimming motion of a live fish.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a body of a fishing lure according to the principles of the present disclosure;

FIG. 2 is a top view of the body of the fishing lure of FIG. 1;

FIG. 3 is a side view of the fishing lure of FIG. 1;

FIG. 4 is a schematic representation of the fishing lure and a strip of fish tissue; and

FIG. 5 is a schematic representation of the fishing lure having the strip of fish flesh secured thereto by a piercing member according to the principles of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

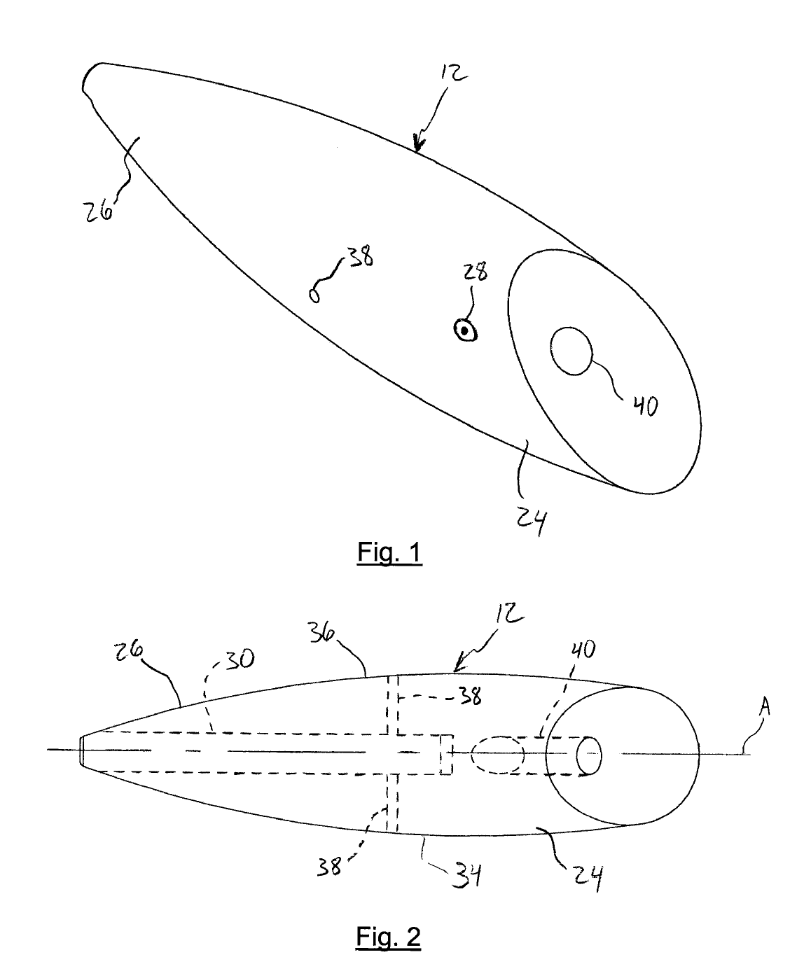

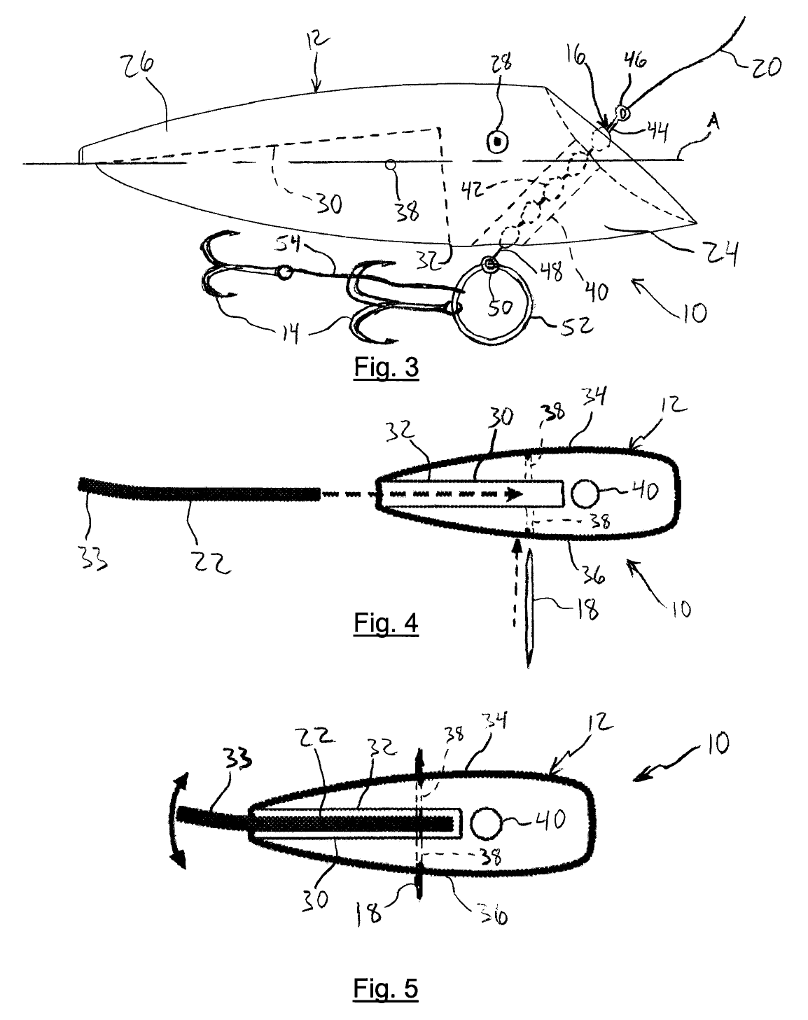

With reference to FIGS. 1-5, a fishing lure 10 is provided. The fishing lure 10 may include a lure body 12, one or more hooks 14, a connecting member 16, and a piercing member 18. A user may attach the fishing lure 10 to a fishing line 20 (FIG. 3), which in turn may be connected to a fishing rod and reel (not shown). As will be subsequently described, the user may cut a fillet 22 from a baitfish and attach the fillet 22 (FIG. 4) to the fishing lure 10. With the fillet 22 attached, the fishing lure 10 may be used to attract and catch fish in a body of water. While the fishing lure 10 is described herein as receiving the fillet 22 of the baitfish, it will be appreciated that the any piece or portion of flesh or tissue of the baitfish or any other fish or animal can be used in addition to or in the place of the fillet 22. Alternatively, an entire baitfish (live or dead) could be received in or attached to the fishing lure 10.

The lure body 12 may be an elongated member formed to generally resemble or formed generally in the shape of a body of a baitfish, for example, or any other aquatic animal. The lure body 12 may include a front portion 24 that may generally correspond to a head portion of the baitfish and an aft portion 26 that may generally correspond to a tail portion of the baitfish. The lure body 12 may include coloring and/or markings that resemble the coloring and/or markings of a baitfish to attract larger fish. As shown in FIGS. 1 and 3, fish eye decals or stickers 28 may be adhered to the front portion 24 of the lure body 12. Alternatively, fish eyes could be painted onto the lure body 12.

The lure body 12 may be formed from a single, solid piece of material, such as a substantially rigid foam or other polymeric material. In some embodiments, the lure body 12 could be formed from a softer, compressible material that generally resembles the compressibility of a live baitfish. It will be appreciated that the lure body 12 could be formed from virtually any material. The lure body 12 may include an elongated cavity or slot 30 formed therein. As shown in FIGS. 2 and 3, the slot 30 may extend generally along a longitudinal axis (A) of the lure body 12. The slot 30 may extend through the aft portion 26 from an intermediate location between the front portion 24 and the aft portion 26. An opening 32 of the slot 30 may be disposed in a portion of the lure body 12 that corresponds to an underside or belly of the baitfish, as shown in the figures. In other embodiments, however, the slot 30 and opening 32 could be formed in an upper portion of the lure body 12 corresponding to a dorsal region or spine of the baitfish. As shown in FIG. 5, the fillet 22 may be received in the slot 30. An end 33 of the fillet 22 may extend out of the slot 30 beyond a rear tip of the aft portion 26 of the lure body 12.

Each lateral side 34, 36 of the lure body 12 may include one or more first apertures 38 extending laterally through the lure body 12 and communicating with the slot 30. The first apertures 38 on each lateral side 34, 36 of the lure body 12 may be substantially aligned with each other. The piercing member 18 may be received through the first apertures 38 and pierce the fillet 22 to secure the fillet 22 within the slot 30. The piercing member 18 could be a wooden or plastic toothpick or a plastic or metallic pin, for example, or any other elongated member adapted to be received in the first apertures 38 and pierce through the fillet 22. In some embodiments, the fillet 22 may be secured to the lure body 12 by any suitable additional or alternative means. For example, the fillet 22 could be tied to the lure body 12 with thread or fishing line.

A second aperture 40 may extend through the front portion 24 of the lure body 12. In some embodiments, the second aperture 40 may be disposed at an angle relative to the longitudinal axis (A), as shown in FIG. 3. The connecting member 16 may extend through the second aperture 40 and may connect the hooks 14 to the fishing line 20. The connecting member 16 may include a flexible metallic or polymeric cable or thread and may include a plurality of spherical metallic weights 42 thereon. A first end 44 of the connecting member 16 may include a first eyelet 46 to which the fishing line 20 may be tied. A second end 48 of the connecting member 16 may include a second eyelet 50. A ring 52 having a larger diameter than the second aperture 40 may be removably attached to the second eyelet 50. In the particular embodiment shown in FIG. 3, a first one of the hooks 14 is connected directly to the ring 52, and a second one of the hooks 14 is connected to the ring 52 via a connecting line or cable 54. It will be appreciated that the hooks 14 and/or the fishing line 20 could be secured to the lure body 12 in any suitable manner. For example, the first and second eyelets 50 could be mounted directly to lure body 12.

With continued reference to FIGS. 1-5, operation of the fishing lure 10 and a method of fishing will be described. As described above, a user may insert the fillet 22 into the slot 30 such that the end 33 of the fillet 22 is protruding outward from the aft portion 26 of the lure body 12. The user may then insert the piercing member 18 through the first apertures 38 and the fillet 22 to retain the fillet 22 within the slot 30. The user may then trim off the ends of the piercing member 18 with scissors, wire cutters or a knife, for example, so that the length of the piercing member 18 is substantially equal to or closer to the width of the lure body 12.

With the lure body 12 secured to the fishing line 20 and the fillet 22 secured to the lure body 12, the user may cast or drop the fishing lure 10 into a body of water. The user may troll with the fishing lure 10, i.e., leave the fishing lure 10 in the water while a boat in which the user is situated moves through the water. Additionally or alternatively, the user may repeatedly cast and reel-in the fishing lure 10. Trolling and/or casting and reeling-in the fishing lure 10 will cause the fishing lure 10 to move in the water and simulate motion of a live baitfish.

When the fishing lure 10 is moving in the water, the end 33 of the fillet 22 may sporadically undulate or flap back and forth, making the end 33 of the fillet 22 appear to larger fish like a tail fin of a live baitfish. In some embodiments, the shape of the end 33 of the fillet 22 and/or the speed in which the fishing lure 10 is moving through the water may make the motion of the end 33 of the fillet 22 look like the motion of a wounded fish, which may be more attractive to some fish species. Furthermore, the solid, structural foamed plastic construction of the lure body 12 may provide a desired level of buoyancy and a desirable level of stiffness that further improves the live-baitfish-motion of the fishing lure 10 as it moves through the water. In addition to the realistic motion of the fishing lure 10 as it moves through the water, the fillet 22 or other piece of tissue provides a scent in the water that attracts larger fish to the fishing lure 10.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A fishing lure comprising:
a body portion shaped to generally resemble a body of a baitfish and including a front portion corresponding to a head of the baitfish and an aft portion corresponding to a tail of the baitfish; and
a cavity formed through an outer surface of the body portion for receiving a quantity of animal tissue therein.

2. The fishing lure of claim 1, wherein the body portion includes an aperture extending laterally through the body portion and the cavity.

3. The fishing lure of claim 2, further comprising an elongated piercing member adapted to be inserted through the aperture and the cavity and pierce the quantity of animal tissue.

4. The fishing lure of claim 1, wherein the cavity includes an elongated slot extending at least partially through a length of the body portion.

5. The fishing lure of claim 4, wherein the cavity extends through a rear tip of the aft portion.

6. The fishing lure of claim 5, wherein the cavity extends into a region of the body portion corresponding to a belly portion of the baitfish.

7. The fishing lure of claim 5, wherein the quantity of animal tissue includes an elongated strip of fish tissue, and wherein a first portion of the elongated strip is received in the cavity, and a second portion of the elongated strip extends out of the cavity beyond the rear tip of the aft portion.

8. The fishing lure of claim 1, wherein the body portion includes an aperture extending therethrough and disposed at an angle relative to a longitudinal axis of the body portion, wherein a first end of the aperture is disposed proximate the cavity.

9. The fishing lure of claim 8, further comprising a connection member extending through the aperture, the connection member including a first end adapted to be connected to a fish hook and a second end adapted to be connected to a fishing line.

10. The fishing lure of claim 9, further comprising a ring engaging the second end of the connection member and the fish hook, the ring having a diameter larger than a diameter of the aperture.

11. A fishing lure comprising:
a body portion having a one-piece construction and include a front end corresponding to a head of a baitfish and an aft end corresponding to a tail of the baitfish;
an elongated slot formed in the body portion and extending through an outer surface of the body portion and along a longitudinal axis of the body portion, the elongated slot extending through the aft end of the body portion from an intermediate location between the front and aft ends of the body portion;
a first aperture extending laterally through an entire lateral width of the body portion and the elongated slot; and
a hook extending from the body portion proximate the elongated slot.

12. The fishing lure of claim 11, wherein an elongated strip of animal tissue is received in the elongated slot and engages a piercing member extending through the first aperture, and wherein an end portion of the elongated strip of animal tissue extends along the longitudinal axis of the body portion and out of the elongated slot beyond the aft end of the body portion.

13. The fishing lure of claim 11, wherein the body portion includes a second aperture extending therethrough and disposed at an angle relative to the longitudinal axis of the body portion, wherein a first end of the aperture is disposed proximate the cavity.

14. The fishing lure of claim 13, further comprising a connection member extending through the second aperture, the connection member including a first end adapted to be connected to the hook and a second end adapted to be connected to a fishing line.

15. The fishing lure of claim 14, further comprising a ring engaging the second end of the connection member and the hook, the ring having a diameter larger than a diameter of the second aperture.

16. A method comprising:
securing a lure to a fishing line, the lure being shaped to generally resemble a baitfish and having a hook connected thereto;
providing at least one portion of at least one of a live baitfish or a dead baitfish;
securing the at least one portion of the at least one of the live baitfish or the dead baitfish to the lure; and
providing relative motion between water and the lure with the at least one portion of the at least one of the live baitfish or the dead baitfish secured to the lure to simulate a swimming motion of a live fish.

17. The method of claim 16, wherein the step of providing the at least one portion of the at least one of the live baitfish or the dead baitfish includes cutting an elongated strip of tissue from a baitfish.

18. The method of claim 17, wherein the step of securing the at least one portion of the at least one of the live baitfish or the dead baitfish to the lure includes inserting a first portion of the elongated strip of tissue into a cavity formed in the lure such that a second portion of the elongated strip extends beyond a rear tip of the lure and moves relative to the rear tip in response to relative motion between water and the lure.

19. The method of claim 17, wherein the step of securing the at least one portion of the at least one of the live baitfish or the dead baitfish to the lure includes inserting an elongated member through an aperture in the lure and piercing the at least one portion of the at least one of the live baitfish or the dead baitfish.

20. The method of claim 19, further comprising trimming a distal end of the elongated member that protrudes outwardly from the lure after the step of piercing the at least one portion of the at least one of the live baitfish or the dead baitfish.
